(19) United States
(12) Patent Application Publication
(10) Pub. No.: US 2003/0128983 A1
(43) Pub. Date: Jul. 10, 2003

(54) Digital RF return over fiber

(76) Inventors: George H. BuAbbud, Southlake, TX (US); Samuel T. Heffner, Hurst, TX (US)

Correspondence Address: F. Drexel Feeling, Esq., JONES, DAY, REAVIS & POGUE, North Point, 901 Lakeside Avenue, Cleveland, OH, 44114, US

(21) Appl. No.: 10/200,924

(22) Filed: Jul. 23, 2002

Related U.S. Application Data
(63) Continuation-in-part of application No. 09/309,717, filed on May 11, 1999, now Pat. No. 6,460,182.
(63) Continuation-in-part of application No. 09/633,320, filed on Aug. 7, 2000.
(60) Provisional application No. 60/307,257, filed on Jul. 23, 2001.

(51) Int. Cl. H04J 14/08

(52) U.S. Cl. 398/71; 398/98

(57) ABSTRACT

A method of transmitting RF return signals from an end user to an RF source is provided. The method comprises the steps of converting RF return signals into RF return data packets having control information, combining the RF return data packets with data packets from other sources to obtain a first collection of combined data packets, and multiplexing the first collection of combined data packets with digital telephony data packets containing samples of POTS signals. The method further comprises the steps of transporting the first collection of combined data packets and digital telephony data packets over an optical fiber, receiving and demultiplexing the first collection of combined data packets and digital telephony data packets, and combining the RF return data packets with data packets from other sources to obtain a second collection of combined data packets. In addition, the method comprises the steps of transmitting the second collection of combined data packets to a burst RF transmitter and extracting a collection of RF return signals from the second collection of combined data packets and transmitting the collection of RF return signals to a television signal source.

### CROSS-REFERENCES TO RELATED APPLICATIONS

This is a continuation-in-part application of application Ser. No. 09/309,717 filed May 11, 1999, and Ser. No. 09/633,320 filed Aug. 7, 2000. Both previous applications have the same title and the same inventor. The present application also has the same inventor. The entire disclosure of U.S. application Ser. No. 09/309,717 filed May 11, 1999, and Ser. No. 09/633,320 filed Aug. 7, 2000 are hereby incorporated into the present application by reference. Priority is further claimed to Provisional Application Serial No. 60/307,257 filed Jul. 23, 2001 with the same title. The entire disclosure of U.S. Provisional Application No. 60/307,257 filed Jul. 23, 2001 is hereby incorporated into the present application by reference.

### BACKGROUND OF THE INVENTION

1. Field of the Invention

The present invention relates to methods and apparatus for carrying on simultaneous communications over a single optical fiber by using two different wavelengths of light, and more specifically to methods and apparatus to provide bidirectional telephonic communication using TDM (time division multiplexing) and digital data transmission such as transmitting Digital Subscriber Line (DSL) at one wavelength of light, and transmitting multicast TV signals in one direction (downstream) at another wavelength. TV control signals are returned by the telephonic communication path to the TV source by digitizing and multiplexing the control signals with the digital data transmission and telephony signals.

2. Description of Related Art Including Information Disclosed Under 37 CFR 1.97 and 1.98

The communications industry is using more and more optical or light fibers in lieu of copper wire. Optical fibers have an extremely high bandwidth thereby allowing the transmission of significantly more information than can be carried by a copper wire transmission line such as twisted pairs or coaxial cable.

Of course, modern telephone systems require bidirectional communications where each station or user on a communication channel can both transmit and receive. This is true, of course, whether using electrical wiring or optical fibers as the transmission medium. Early telephone communication systems solved this need by simply providing separate copper wires for carrying the communications in each direction, and this approach is still used in older installations where telephony is the only required service. It is also often used even where digital transmission service is demanded as the signals get closer to the end users. Although twisted pairs and coaxial cables are used in homes and distribution terminals close to the home end user, some modern telecommunication systems now use micro-wave and optic fibers as transmission mediums. In addition TCM (time compression multiplexing) is often used in optical transmission so that a single optical fiber can carry communications in both directions.

Because of extremely high band widths available for use by an optical fiber, a single fiber is quite capable of carrying a great number of communications in both directions. One technique of optical transmission is WDM (wavelength divisional multiplexing) and uses different wavelengths for each direction of travel.

Yet another and less expensive technique for using a single optical fiber for telephone systems is a TCM (time compression multiplexing) system. The system operates at a single frequency or wavelength of light and uses a single optical fiber and often even a single diode, for both converting electrical signals to optical signals and converting received optical signals to electrical signals. TCM systems have the obvious advantage of requiring fewer components.

However, as mentioned above, optical fibers have extremely high bandwidths and use of an optical fiber carrying a single wavelength of light as a TCM telephone path is still a very ineffective use of the fiber and, in fact, the available bandwidth of an optical fiber makes it possible to use a transmission technique such as TCM at one wavelength and then by the use of WDM technology to use another technique at a second wavelength.

Another area of rapidly growing technology is providing unidirectional TV signals by cable to a multiplicity of subscribers or users (multicast). In the past, such signals were and still are typically transmitted by the use of coaxial cables (e.g. cable TV). However, the use of optical fibers for transmission allows broad band transmission to a large numbers of customers and, since substantially all of the transmission of TV signals is one way (i.e. unidirectional), if a single optical fiber were used solely for the TV signals there would be almost no use of the selected wavelength of light for carrying return signal, which are typically control or information signals.

### SUMMARY OF THE INVENTION

A method of transmitting RF return signals from an end user to an RF source is provided. The method comprises the steps of converting RF return signals into RF return data packets having control information, combining the RF return data packets with data packets from other sources to obtain a first collection of combined data packets, and multiplexing the first collection of combined data packets with digital telephony data packets containing samples of POTS signals. The method further comprises the steps of transporting the first collection of combined data packets and digital telephony data packets over an optical fiber, receiving and demultiplexing the first collection of combined data packets and digital telephony data packets, and combining the RF return data packets with data packets from other sources to obtain a second collection of combined data packets. In addition, the method comprises the steps of transmitting the second collection of combined data packets to a burst RF transmitter and extracting a collection of RF return signals from the second collection of combined data packets and transmitting the collection of RF return signals to a television signal source.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 is a block diagram showing the transmission and distribution of a typical prior art coaxial TV and POTS telephone system;

FIG. 2 shows a POTS telephone system and a fiber optic TV distribution system having 1550 nanometer light carrying TV signals in one direction and 1310 nanometers of light carrying RF return signals in the other direction;

FIGS. 3, 4A and 4B show a block diagram of an embodiment of the present invention incorporating portions of a POTS telephone system and the TV signal distribution system which uses a single optical fiber for carrying the multicast TV signals at 1550 nanometers of light downstream and bidirectional telephony and digital data signals in both directions at 1310 nanometers;

FIG. 5 shows a block diagram of the invention of FIG. 3 used with a FTTH (Fiber To The Home) system.

FIG. 6 shows a detailed block diagram of the invention of FIG. 3 used with a hybrid optical and coaxial system or a FTTC (Fiber To The Curb).

### DETAILED DESCRIPTION OF THE PREFERRED EMBODIMENT(S)

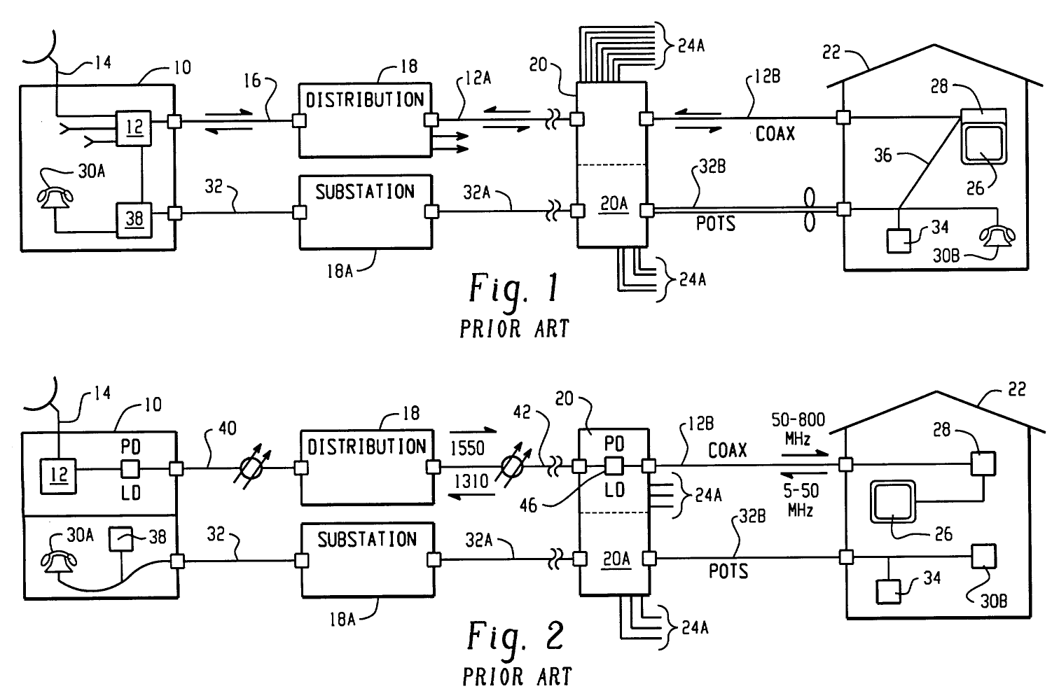

Referring now to FIG. 1, there is shown a typical transmission and distribution system for cable TV and normal telephone service, referred to as POTS (plain old telephone service). As shown, cable TV source location 10 has cable TV transmission equipment 12 which may originate from several sources including a satellite receiver 14. The TV equipment 12 would then amplify these signals and send them out typically on a coaxial line such as line 16 to a distribution system which may include several stations such as station 18 where the signals are again amplified and further distributed to an even larger multiplicity of locations. Such re-amplification and further distribution may occur several times but eventually the TV signals will arrive at a local distribution terminal 20 by means of a coaxial cable 12A from which they are then distributed to a home or building 22 by a coaxial cable 12B. As shown distribution terminal 20 may also provide TV signals to other buildings or homes such as indicated by bracket 24. Once the TV signals are received at building 22, they will then typically be provided to a TV set 26 directly or to a set-top or cable TV box 28. If the signals are first provided to the set-top box 28, they will subsequently be provided to TV set 26. It should be appreciated that the direction of travel for such multicast signals is unidirectional and downstream. That is, they travel primarily from the cable TV signal source 10 to the set-top box 28 or TV set 26 in the building or home 22 at frequencies within a frequency band of between 200-870 MHz. TV channels having frequencies of between 200-870 MHz of which 200 MHz to 550 represents analog cable TV and 550 to 870 MHz represent digital or satellite TV. If RF return information is to be carried upstream or back to source 10, it will typically be at between 50-200 MHz. It should be understood that the bandwidths for analog and digital TV signals are not fixed and may be selected to have values different than the 200-550 MHz for analog and 550 MHz for DSS. For example, some systems have chose to allocate the full 200-870 MHz for analog signals and use a 950 to 2050 MHz band for digital TV signals.

Also shown is a typical telephone system or POTS which, of course, for years represented two-way communication typically carried by means of a twisted pair of wires. In the example shown in FIG. 1, if someone at the cable TV signal source location 10 (or any other location for that matter) wishes to talk with someone at building 22, the telephone 30A is used in its normal manner. The two-way conversation is carried on between the person in building 10 using telephone 30A and by a person using telephone 30B in the home or building 22. In the past, this communication was carried through a series of pairs of twisted wires such as indicated by 32, 32A, and 32B. In recent years, the regular telephone distribution system has also been used to provide communications between computers. This is done by the use of a modem 34 which connects a computer to the telephone line. As was the case with the TV signal distribution, there are typically several stations or substations such as substation 18A between the two telephones 30A and 30B located at the building 10 and the building 22, respectively. Such distribution terminals or stations allow telephone services between all subscribers with which we are all well aware. However, as shown in portion 20A of distribution terminal 20, there may also be several other buildings or homes connected to telephone distribution terminal 20 as indicated by bracket 24A. As was discussed earlier, communications between buildings 10 and 22 were typically accomplished through regular telephone service by individuals talking to each other. However, with more efficient automation, telephone lines may also be connected up to the set-top box 28 as indicated by wires 36. In addition, in the distribution terminal at the cable TV signal location, there is also a modem 38 which provides a telephone connection to the TV signal equipment 12, such that it is now possible that movies or information concerning the TV signals and TV equipment can be communicated automatically between the two locations.

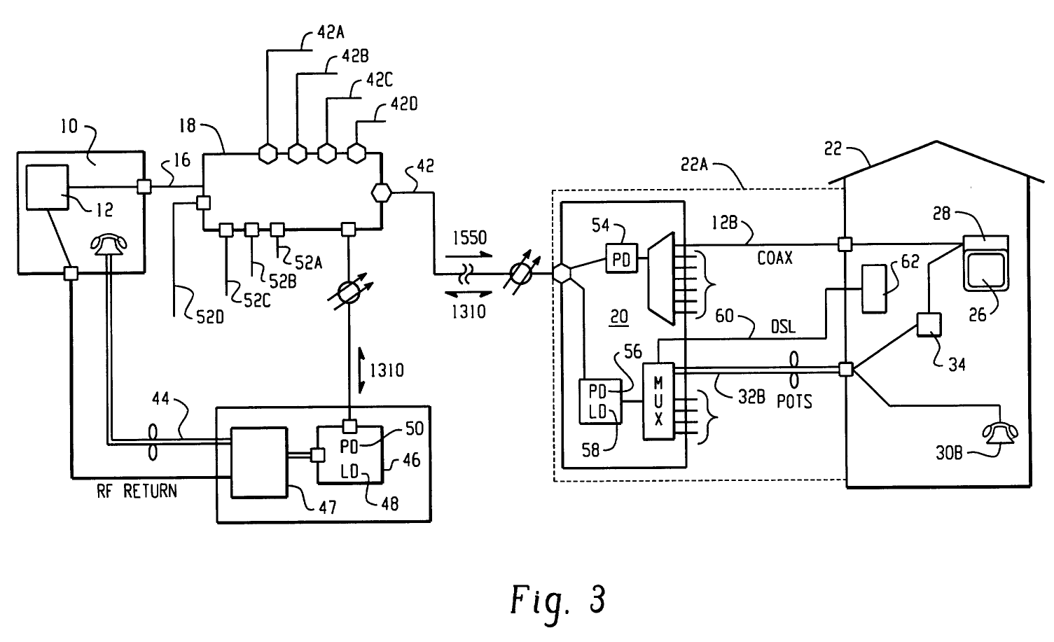

As demands increase for more and more TV channels and better and more efficient transmission techniques without disruption and interference, the long runs of coaxial cable have simply become inefficient and inadequate. Thus as is shown in FIG. 2, there is an improved prior art system for the transmission of TV signals between the TV signal source location 10 and the building or home 22. In the systems shown in FIG. 2, there is also shown a standard telephone or POTS system as discussed above.

In the improved prior art television transmission system, however, the transmission is achieved by a fiber optical cable as indicated by fiber optical cables 40 and 42. As shown in FIG. 2, and in a FTTC (Fiber To The Curb) system, the same coaxial cable 12B exist between the distribution terminal 20 and the home or building 22. However, also as shown distribution terminal 20 includes new equipment 46 which receives the light transmitted downstream on fiber optic 42 and converts it to electrical signals and conversely receives electrical signals from 12B and converts the electrical signals to light signals for transmission upstream on fiber optic 42. However, as will be appreciated by those skilled in the art, the TV signals from the TV signal source building 10 normally travel downstream only and are continuous. Thus, if bidirectional communications between the cable TV signal source 10 and the distribution terminal 20 are to take place, some sort of sharing of the individual fiber optics 40 and 42 as well as the copper wire 12B must be provided. Thus, in the example shown, the TV signals travel in a single direction (i.e., downstream) from the TV signal source at location 10 to the home or building 22 by light waves having a wavelength of 1550 nanometers. Any return communication traveling on optical fibers 40 and 42 may be carried at a different wavelength of light such as 1310 nanometers which travels upstream to the TV signal source location 10. Likewise, if bidirectional communication is to take place on the single coaxial cable 12B between distribution terminal 20 and home or building 22, the transmission of such bidirectional communication transmission is typically at different frequencies. Thus, in the illustrated example, electrical signals having a frequency band of between about 200 and 2050 MHz which travel in a single direction from distribution terminal 20 to a multitude of homes or buildings 22 are extracted from the 1550 nanometer light waves. The return digital signals from a cable modem or set-top box at building 22 are carried at about 5 to 50 MHz back to the distribution terminal 20 and then used to modulate light waves having a wavelength of 1310 nanometers. Thus, it is seen that this prior art system used a single fiber optic cable as well as using existing infrastructure copper wiring such as coaxial cable to transmit a broad frequency band of multicast TV signals carrying multiple channels of TV information at one wavelength of light. The individual TV channels are then converted to electrical signals at a specific frequency within a selected frequency band, such as for example, only the 200-870 MHz frequency band for CATV and 950-2050 MHz (Digital Satellite Signals for DSS). Conversely, electrical control or RF return signals within the 5-50 MHz frequency band were converted to light at a wavelength different from that provided in the downstream mode and transmitted back to the TV signal source location 10. The return wavelength of light in the illustrated example is 1310 nanometers.

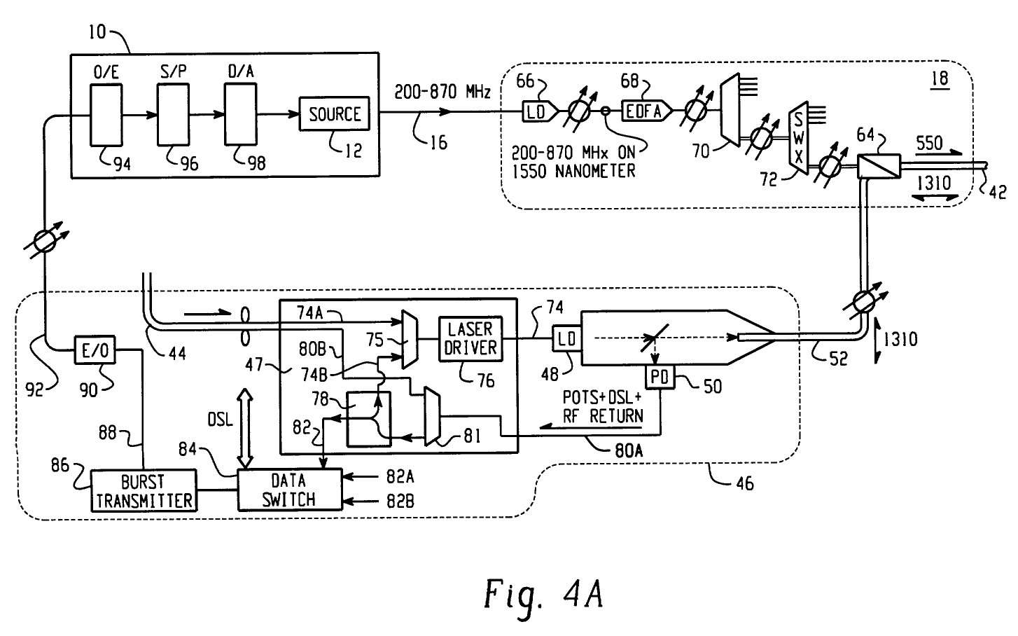

Referring now to FIG. 3 there is shown a simplified block diagram of the overall operation of the present invention which, discusses a FTTC embodiment. This embodiment takes partial advantage of the existing telephone and coaxial TV distribution systems while also using a single optical fiber 42 for part of the bidirectional telephone transmission (POTS) as well as part of the transmission path between the TV signal source location 10 and the building or home 22. It should be noted that, although the following discussion is in terms of a single direct path for the coaxial and optical fiber cable 42 between two locations 10 and 22, in actuality there will be a significant amount of multiplexing and de-multiplexing such that many, many subscribers or customers may be serviced by the single optical fiber and other multiplexed cables. It should also be noted that there may also be several amplification stations located at various locations in the distribution path. FIG. 3 also illustrates by the dotted line 22A that, according to a second embodiment, the present invention is also suitable for use with a FTTH (Fiber To The Home) system.

Further, as is shown, in addition to the optical fiber 42 traveling between distribution terminal 18 and a remote distribution terminal 20, there will be other optical fibers as indicated by optical fibers 42A through 42D which extend between distribution terminal 18 and other remote distribution terminal (not shown) similar to remote distribution terminal 20 or a home 22A. Each of the optical fibers 42A through 42D are capable of carrying light at both 1550 nanometer and 1310 nanometer.

As shown, TV signal source location 10 provides signals from equipment 12 and, in this illustrated embodiment, the TV signals are shown as being between 200 to 870 MHz signals which may be provided on copper wire, such as coaxial cable 16, or alternately could also be carried on an optical fiber, such as optical fiber 40 shown in FIG. 2. Copper coaxial cable 16 may carry, for example only, analog cable TV (CATV) signals having a band width of 200 to 870 MHz, and satellite or other digital TV systems (DSS) between about 950 and 2050 MHz to distribution terminal 18 which uses the electrical TV signals to modulate light having a selected wavelength. In one preferred embodiment a particular selected wavelength is 1550 nanometers. Thus the light waves are provided to each of the individual optical fibers 42-42D and travel in a single direction from distribution terminal 18 to an equal number of remote terminals, such as distribution terminal 20 or home 22A. Also as shown, electrical telephony signals may be carried by copper wires 44 which represent a twisted pair of normal telephone communication wires to a substation 46 where electrical telephony signals traveling downstream are multiplied or combined by Routing Multiplexer circuitry 47 with DSL signals, as will be discussed hereinafter, and then used to modulate light at a selected frequency (typically by a laser diode—(LD) 48). In the same manner, light at that same frequency traveling upstream previously modulated by various types of digital signals such as digital electrical telephony signals is processed to recover or detect (typically by a photo detector—(PD) 50) the upstream digital signals. Thus, the fiber optic cable 52 shown between distribution terminals 18 and substation 46 carries bidirectional telephony signals at a single wavelength of light typically selected to be about 1310 nanometers. The light signals at 1310 nanometers are able to travel in both directions on the single fiber optic cable 52 by the use of TCM (Time Compression Multiplexing). Additionally, it is possible to transmit more than one optical signal on the same wavelength within a fiber, either unidirectionally or bidirectionally without using TCM. In such case, the optical signals are transmitted concurrently without regard to any time period as in TCM. Although TCM is not suitable for higher density or multicast signals such as TV signals, it is quite adequate for lower frequencies suitable for transmitting the human voice as well as frequencies up to about 50 to 64 MHz, which is well above human hearing. Time compression multiplexing simply stated means that successive specific periods of time are continuously broken up in two portions such that signals travel in one direction during one portion and in the opposite direction during the other portion. Also as shown and as was discussed above with respect to optical fibers 42 through 42D, there will be a plurality of additional optical fibers 52A through 52D also carrying many other digital signals by TCM at 1310 nanometers.

Thus, distribution terminal 18 receives fiber optic cable 52 along with fiber optic cables 52A through 52D, each carrying the 1310 TCM (time compression multiplexed) modulated light and also according to one embodiment receives 200 to 870 MHz TV signals from the TV signal source location 10. The 200 to 870 MHz electrical signals are used to modulate light having a wavelength of 1550 nanometers. Distribution terminal 18 then combines by WDM (Wave Division Multiplexing—not shown) the plurality of 1310 nanometer signals along with the 1550 nanometer signal such that optical cable 42 carries the TV signals in a downstream direction on 1550 nanometer light and carries digital TCM signals in both directions on 1310 nanometer light. Of course, fiber optical cables 42A through 42D also carry the 1550 nanometer light and the 1310 nanometer light in a similar manner.

At the remote downstream distribution terminals such as distribution terminal 20, and as will be discussed in detail later, the downstream traveling TV signals on the 1550 nanometer light are then recovered as TV signals having a band width of between 200 and 870 MHz (typically by a photo detector 54). They are then distributed to various locations including home or building 22 as was discussed with respect to FIGS. 1 and 2 above. In a similar manner, the bidirectional TCM signals traveling on 1310 nanometer light waves are routed to other equipment in distribution terminal 20 which recovers the electrical DSL and digital telephony signals by photo detectors—(PD) 56 from the 1310 nanometer light waves traveling downstream and uses the electrical digital telephony signals and digital data signals (DSL) traveling upstream to modulate light waves having a wavelength of 1310 nanometers by laser diode—(LD) 58. The electrical digital telephony signals and digital data signals may then be distributed from distribution box 20 by twisted wire pair 32B to the telephone 30B or other telephony equipment such as the 56K telephone modem 34 or a DSL line 60 to a computer 62 at home or building 22.

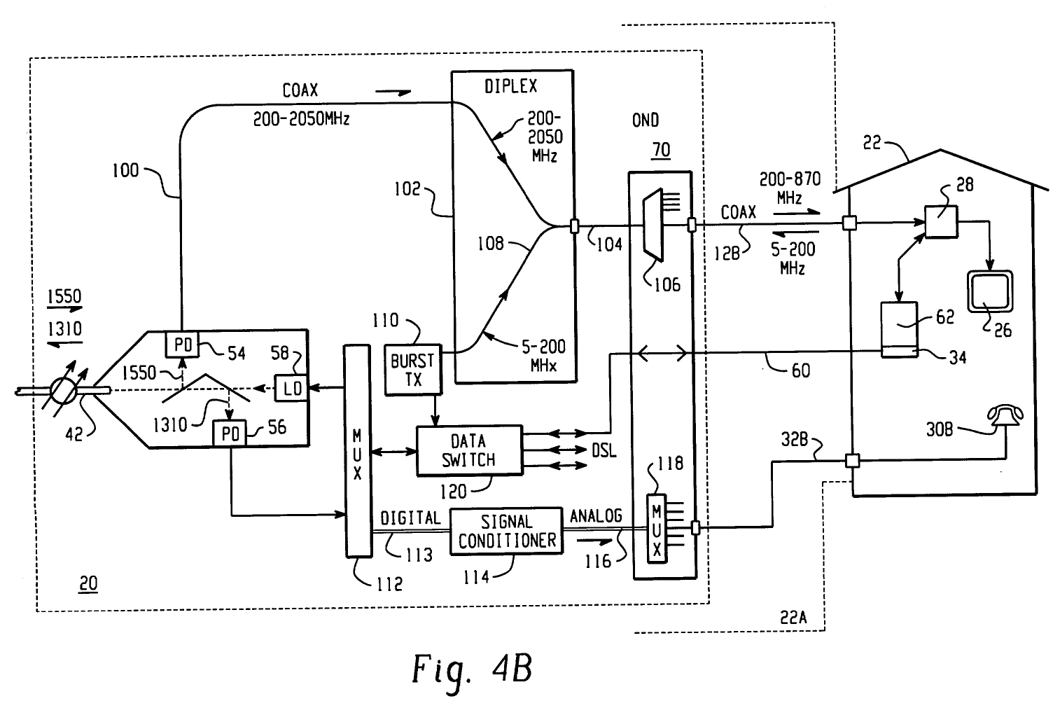

As was discussed with respect to the system of FIG. 2 above, it may be desirable to transmit cable modem signals, set-top box signals or other types of television-related control signals or “purchasing information” either analog and/or digital signals from the set-top box 28 or TV set 26 at building 22 back to the TV signal source location 10. As discussed earlier with respect to FIG. 2, since the downstream transmission of TV signals is substantially continuous, such return information will be carried upstream at a different frequency band on the copper cable 12B and on a wavelength different than 1550 nanometer on fiber optic cable 42. Thus, in addition to the telephone service which travels upstream on a wavelength of light of 1310 nanometers, distribution terminal 20 will also use the DSL signals or digital data and the electrical TV-related signals which will be in the 5-200 MHz band to modulate the 1310 nanometer light. This wavelength of light carrying the DSL service, cable modem or digital return TV-related signals and the digital telephone signals all travel upstream on the 1310 nanometer light in the upstream portion on the TCM cycle traveling from distribution terminal 20 to distribution terminal 18. The 1550 nanometer light traveling downstream is then separated from the 1310 nanometer upstream light by Wave Division Multiplexer such as WDM 64 shown in FIG. 4A at distribution terminal 18. Both the actual telephony signals and the DSL service, cable modem or TV-related control signals carried by the 1310 nanometer light are then provided to the plurality of fiber optic cables 52 through 52D to the appropriate distribution terminals such as distribution box 46 where they are then extracted or recovered as the normal telephone electrical signals at 155 Mbps and the RF return signals at 5-42 MHz. After being extracted, the telephony signals and the RF return signals are then provided in a normal fashion to typical telephone equipment and the TV equipment 12, respectively.

Although in the previous discussion of FIG. 3, the modulation of light waves by electrical signals for both telephone service and for TV signals is shown occurring at a remote distribution box 20, it will be appreciated that it may be advantageous that an optical fiber would be connected into a home or building 22 and the recovery of electrical signal from light and vice versa will take place in the building 22 itself as indicated by dotted line 22A.

Thus, there has been discussed to this point generalized concepts for a new and improved telephony and TV signal distribution systems.

Referring now to FIGS. 3, 4A and 4B, there is provided a more detailed description of the system of FIG. 3 discussed above. As shown, the TV signal source 12 at location 10 provides output TV signals, for example only, at 200 to 870 MHz traveling downstream on copper wire 16. The electrical signals are then provided to laser diode 66 where the electrical signals used to modulate light having a wavelength of 1550 nanometers. The modulated 1550 nanometer light is then eventually provided to a plurality of WDMs (wave division multiplexers) such as to a WDM 64 which is also connected to optical fiber 52 carrying light at a wavelength of 1310 nanometers and will be discussed later. Although it is possible that the output of the light emitting diode 66 could be provided directly to a WDM 64, typically the light would go through at least one light amplifier such as EDFA (erbium doped fiber amplifier) 68. The amplified light signal from amplifier 68 would then typically pass the light through a first light splitting circuit 70 and then again perhaps to another light splitting circuit 72 such as a SWX circuit. The output of the splitter 72 would then be provided to the plurality of WDMs including WDM 64. As shown in FIG. 3, the outputs of the plurality of WDMs such as WDM 64 are connected to a plurality of light fibers 42 through 42D.

Also as shown, multiplexed POTS telephone service (i.e., information from up to 24 TV customers) on copper wire 74 and DSL service on wire 74B are combined at multiplexer 75 such that the combined signals then travel downstream typically with a data rate of about 8 Mbps or 0 to 3 MHz (could be up to about 60 MHz) and are provided through a laser driver 76 to laser diode 48. These electrical signals are then used to modulate light generated by diode 48 having a wavelength of about 1310 nanometers. This modulated light is provided to optical fiber 52 as shown. Other POTS and DSL signals are similarly provided to optical fibers 52A through 52D and in turn to distribution terminal 18 and the appropriate WDM as shown in FIG. 4A.

As was discussed earlier, both telephone and DSL service are typically TCM (time compression multiplexing) so as to provide for bidirectional communication at a single wavelength of light. Therefore as shown, light traveling upstream and leaving optical fiber 52 is directed toward a photo or a light detection diode 50 which receives the 1310 nanometer light and recovers the upstream digital signals having a frequency of about 60 MHz or less.

Thus, the input electrical digital telephone and DSL signals to laser diode 48 from line 74 and the output electrical telephony signals from Routing Multiplexing Circuit 47 and light detection diode 50 on line 80B actually represent a typical pair of wires used in normal POTS telephony service as indicated at 44. However, in addition to the electrical telephony and DSL signals on line 80B, light detection diode 50 will also detect the digital RF Return signals from various downstream customers, as will be discussed in more detail hereinafter. These digital RF Return signals are separated from the POTS and DSL signals in Routing Multiplexer Circuit 47 by multiplexer 81 and diplexer 78, respectively, and provided as an output on line 82 to a data switch 84.

More specifically, HDT or substation 18 receives the modulated 1310 nanometer light from optical fiber 52 and provides it to photo diode 50 which then generates electrical signals which include or carry the digital POTS, the DSL and digital RF Return signals. As will be discussed later, the digital telephony signals are organized as cells or packets along with the RF return and DSL data cells/packets. The RF return and DSL data cells/packets are then separated from the POTS data packets by Demultiplexer 81 located in Multiplexing/Demultiplexing Circuitry 47 and provided on line 82 to data switch 84. The POTS signals are provided to line 80B for further processing in a well-known manner and will not be discussed further. The data cells/packets containing both the digital RF Return signals and the DSL signals are combined with data cells/packets from other optical links by data switch 84 as indicated by inputs 82A and 82B. It is, of course, important that the timing relationship of all the digital data packets be preserved by data switch 84. It should also be understood, and will be discussed later, that each digital RF Return cells/packets will include a header identifying it as carrying RF Return signals so that it can be easily separated from the DSL data cells/packets and provided as an output on the DSL input/output line 85. After the RF Return cells/packets have been combined with other RF Return packets from inputs 82A and 82B, the combination of packets are provided to Burst RF Transmitter and circuitry 86. Circuitry 86 receives the combination cells/packets, disassembles them into bits and then reassembles them into a segment bit stream. The RF bits in the bit stream are then demodulated RF burst and then encoded into the appropriate frequency and modulation scheme as an output signal on line 88 which transmits the optical signal to the CMTS (Cable Modem Termination System). Then, as shown in FIG. 4A, the output of circuitry 86 on line 88 may then provided to another E/O (electrical-to-optical) device 90 operating at 1 Gbps (giga bit per second). This optical output may then be transmitted by optical fiber 92 to CMTS (cable modem transmission source) at location 10 where the TV signal source 12 is also located. The light traveling through optical fiber 92 is then received by O/E (optical-to-electrical) converter 94 and the resulting electrical signals are provided to S/P (serial-to-parallel) converter 96. This parallel digital information may, if necessary, be provided to D/A converter 98, which in turn provides a control signal to the TV signal source 12. This analog signal may of course be a control signal or other information related to a specific TV customer or subscriber. Of course, if the TV signal source can accept digital signals, there would be no need for the D/A converter 98.

From the above discussion, it should be noted that since the electrical RF return data recovered at burst transmitter 86 is again converted to optical signals as shown at E/O converter 90 in FIG. 4A, and since the information carried by the RF return data is not actually used or needed by the HDT/CO/HE equipment, it may be advantageous to transmit the signals on to the source 12 without actually recovering the RF return data. This approach, as will be discussed below, is also useful if the actual burst transmitter circuitry 86 is not programmed as to the actual frequency or protocol needed or used to transmit the data. However, for many, if not most, applications, the protocol will be known or programmed into the Burst transmitter. For example, the protocol could be a DOCSIS (Data Over Cable System Interface Specification) or any suitable transmission protocol. Therefore, if the frequency or protocol is “known” or programmed into the Burst transmitter circuitry, then it is necessary that only the appropriate frequencies be digitized. Since the frequency band to be digitized will be much smaller than the full frequency band available for a burst transmission, much less memory and less expensive equipment may be used. Assuming a carrier band of 5-65 MHz, the protocol frequency may, for example, be centered around 30 MHz with a 3 MHz bandwidth used for modulation. Therefore, with a DOCSIS QPSK (Quad Phase Shift Keying) protocol providing 2 bits/cycle, the system would be required to handle only 6 Megabits of data (3 MHz×2 bits/cycle=6 Megabits). Therefore, for a one (1) millisecond time period, the system would handle six (6) K bits (6×10⁶×10⁻³=6 K bits).

However, as mentioned above, if the protocol or frequency being used is not known, or if it is desirable to provide equipment that can handle many different protocols which operate at frequencies across the allotted 5-65 MHz band, then it will be necessary to sample and digitize the complete band which may, for example, require about 48K bits of memory rather than 6K bits.

Referring again to FIGS. 3 and 4B, optical fiber 42 is shown being received at distribution panel 20. As shown optical fiber 42 is carrying television signals in one direction (downstream) by light having a wavelength of 1550 nanometers at the same time it carries DSL and bidirectional telephone communications using TCM (time compression multiplexing) by light having a wavelength of 1310 nanometers. As shown, the light having a wavelength of 1550 nanometers is directed towards a photo detector 54 which recovers and extracts the electrical television channel signals having a band width of between 200 and 2050 MHz, for example. These electrical television signals are then provided by coaxial cable 100 to a diplex circuit 102 which has an output 104 provided to splitting circuit 106. Also as shown and as will be discussed hereinafter diplex circuit 102 also separates out electrical signals having a frequency of between 5 and 200 MHz traveling in the opposite direction on line 108. One of the outputs of splitter or distribution circuit 106 carrying the 200 to 870 MHz electrical signals will then be provided as shown in FIG. 4B by means of coaxial cable 12B directly to TV set 26 or to another TV-signal using device such as set-top box 28, and then to TV set 26. Also, in the building 22 there is shown a computer 62 connected to DSL line 60 by means of modem 34, and telephone 30B connected to the POTS lines 32B. The RF return signal or TV-related signals sent back to the TV source location 10 may result from several sources. As an example only, one possible signal or instruction appropriate for being returned to source 10 is for the set-top box 28 to sense that the television signals being received need to be either decreased or increased in amplitude or strength. Alternately, it may be that the customer or user of the television decides to purchase a particular pay-on-demand movie. Still another source of information may be an input from the computer 62 provided to the set-top box carrying information or requesting information, or the cable modem 34 connected to computer 62 may send signals upstream on coaxial cable 12B. Such information is provided back to the TV source location 10. The set-top box 28 (as example only) will convert the information into an electrical signal having a frequency between 5 and 200 MHz which is inserted on coaxial cable 12B and transmitted to distribution terminal 20. It will be appreciated that coaxial cable 12B can carry information in both directions if the frequency band for the two directions is sufficiently separated. The 5-200 MHz television-related signals are then routed to the diplex circuitry 102 where the electrical signals having a frequency of 5 to 200 MHz are split out and provided on line 108 to a Burst Receiving Circuit 110. The Burst Receiving Circuit or transmitter 110 could be selected as a DOCSIS (Data Over Cable System Interface Specification) or other proprietary system.

Now referring again to the input cable 42 which, in addition to carrying light having a wavelength of 1550 nanometers downstream as was previously discussed, is also carrying light at 1310 nanometers downstream for the DSL signals and bidirectional digital telephone communication using TCM (time compression multiplexing). Thus, the light having a wavelength of 1310 nanometer is provided to a photo detector 56 which, after demultiplexing by multiplexer 112, along with Signal Conditioner 114 recovers the downstream telephony electrical signals from the 1310 nanometer light traveling downstream and, inserts them on line 116 which carries them to a distribution multiplexer 118. The POTS signal may then be routed to line 32B connecting home 22 to the distribution panel 20 by a normal twisted pair of telephone wires. The upstream traveling POTS service travels on one of the wires of twisted pair 32B, through multiplexer 118 back to Signal Conditioner 114 and then to multiplexer 112 where it is combined with DSL packets and RF Return Data Packets into a TDM transport frame suitable for optical transmission. These electrical signals are then provided to a laser diode 58. Laser diode 58 then uses the electrical signals carrying the 5 to 200 MHz television-related signals, DSL signals and telephony signals to modulate light traveling upstream and having a wavelength of 1310 nanometers. This modulated light is then coupled again to optical fiber 42. Thus, as was discussed earlier, the fiber optic 42 carries the upstream traveling 1310 nanometer light to distribution panel 18 which also receives 1310 nanometer light from a plurality of similar optical fibers. Distribution terminal 18 then directs the 1310 nanometer light to distribution box 52 where the light is split and converted to electrical signals to provide DSL service, telephony service and television RF Return signals as was discussed above.

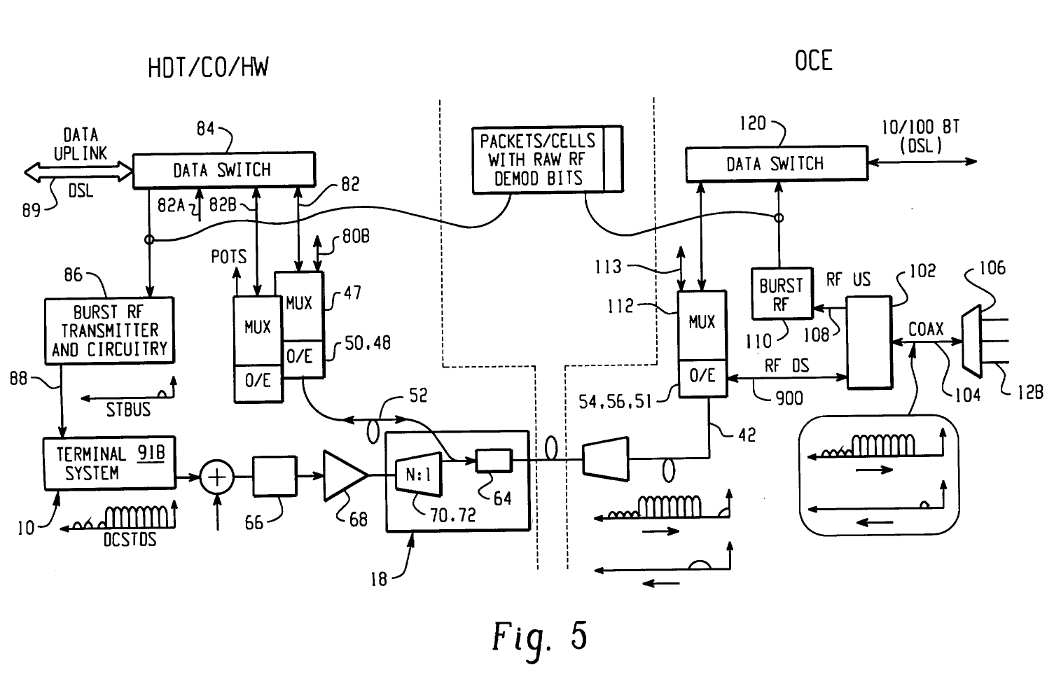

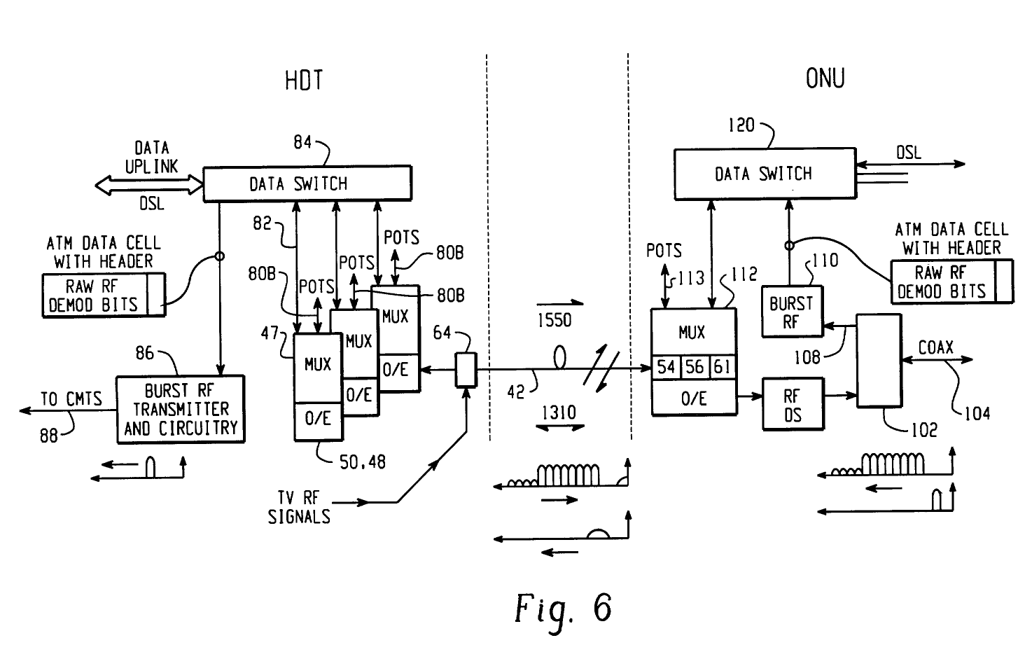

As shown in FIGS. 3, 4A, 4B and 5 according to one embodiment employing FTTC (Fiber To The Curb) technology, a large number of user locations such as home 22 are connected to distribution terminal 20 for both the 5-200 MHz RF return signals and digital POTS signals. It will be appreciated that the RF return signals may include various type of signals such as cable modem signals, set-top box signals, etc.

More specifically, as shown in FIG. 4B, the set top box signal, such as QAM and/or QPSK (Quad Phase Shift Keying) RF bursts are provided through diplexer 102 to Signal Conditioning and Burst Transmitter 110 where the RF bursts are converted to a segmented bit stream and assembled into data cells/packets. Burst transmitter 110 also encodes the RF return path address, the carrier frequency and the modulation scheme onto a header of each data cells/packets. The RF Return data cells/packets are then combined by Data Switch 120 with other data cells/packets such as data cells/packets from DSL service. The combined RF return data cells/packets and other types of data packets (e.g., DSL) are then provided to multiplexer 112 where they are multiplexed with POTS data cells/packets from conditioning circuitry 114. The fully multiplexed data stream typically operates at a rate of 25 Mbps (e.g., 18 Mbps C/P and 7 Mbps P/D), and is provided to diode 58 where it modulates the 1310 nanometer light for the return portion of the TCM cycle. The modulated light is then transported by an optical fiber 42A to distribution terminal or HDT 18 where electrical signals carrying the DSL, Return RF digital signals and the digital telephony signals are extracted as discussed above.

Thus, there has been discussed to this point a new and novel communication transmission system using a single optical fiber as part of the communication path along with parts of an existing telephone communication system and parts of an existing cable TV distribution system.

The corresponding structures, materials, acts, and equivalents of all means or step plus function elements in the claims below are intended to include any structure, material, or act for performing the function in combination with other claimed elements as specifically claimed.

It is claimed:

1. A method of transmitting RF return signals from an end user to an RF source comprising the steps of:
converting RF return signals into RF return data packets, each packet having an address path and control information;
combining said RF return data packets with data packets from other sources to obtain a stream of combined data packets;
multiplexing said stream of combined data packets with digital telephony data packets containing samples of POTS signals;
transporting said stream of combined data packets and digital telephony data packets over an optical fiber;
receiving and demultiplexing said RF return and other data packets from said POTS data packets;
combining said received RF return data packets and other data packets with data packets from other optical fibers;
transmitting said received combined data packets to a burst RF transmitter and extracting a stream of RF return signals from said combined data packets; and
transmitting said stream of RF return signals to a television signal source.

2. The method of claim 1 wherein said stream of combined data packets are used to modulate a 1310 nanometer light wave for transmission over said optical fiber.

3. The method of claim 1 wherein said step of converting RF return signals comprises the steps of:
demodulating said RF burst signals to recover a raw bit stream;
assembling said raw bit stream into data packets; and
encoding a path address of said RF return signals of each data packet on a header of each packet to obtain said stream of data packets.

4. The method of claim 1 wherein said step of extracting said stream of data packets transported over said optical fiber comprises the steps of:
disassembling said data packets into bits;
generating a bit stream segment and assembling said bits into cells or packets of RF return signals;
modulating said bits into RF burst signals with a corresponding frequency and modulation scheme according to the header information of each said packet; and
transmitting an RF return data stream to the CMTS (Cable Modem Termination System).

5. The method of claim 1 wherein substantially all of a fully allotted frequency band for the burst transmitter is sampled and digitized in said transmitting of said combined data packets to said burst transmitter.

6. The method of claim 1 wherein said other data packets are DSL data packets.

7. A method of providing DSL service and television signals to subscribers and bidirectional digital telephony communications to said subscribers through a single optical fiber comprising the steps of:
transmitting light at a first wavelength carrying DSL signals and digital telephony signals from a first plurality of subscriber devices from a first end to a second end and transmitting light at a second wavelength carrying television signals from a television signal source through an optical fiber from said first end to said second end;
receiving said first wavelength of light and extracting first electrical signals within a first frequency band and representative of said plurality of digital telephony signals and said DSL signals from said first wavelength;
receiving said second wavelength of light and extracting second electrical signals within a second frequency band and representative of said television signals from said second wavelength;
transmitting said digital telephony electrical signals to a plurality of telephone-related devices, said DSL electrical signals to a plurality of DSL devices and said second electrical signals to a plurality of television signal receiving devices;
generating a plurality of digital return electrical telephony signals and DSL signals within said first frequency band and a plurality of television-related digital electrical signals within said first frequency band representative of television-related information from said subscribers;
multiplexing said digital return electrical telephony signals, said DSL signals and said television-related digital electrical signals into a data stream;
modulating light at said first wavelength with said data stream;
transmitting said modulated light from said second end to said first end;
receiving said modulated light and generating a plurality of electrical signals representative of said return digital electrical telephony signals and said DSL signals and said television-related information;
transmitting combined data packets to a burst RF transmitter and extracting a stream of RF return signals from said combined data packets; and
transmitting said digital return electrical telephony signals and said DSL signals to said first plurality of subscriber devices, and said RF return electrical signals to said television signal source.

8. The method of claim 7 wherein said first wavelength of light is 1310 nanometers and said second wavelength of light is 1550 nanometers.

9. The method of claim 1 wherein said first frequency band is between about 50 and 200 MHz.

10. The method of claim 9 wherein said second frequency band is between about 200 MHz and 870 MHz.

11. The method of claim 7 wherein said step of extracting said stream of data packets transported over said optical fiber comprises the steps of:
disassembling said data cells into bits;
generating a bit stream segment;
assembling said bits into cells or packets of RF return signals;
modulating said cells or packets of RF return signals into RF burst signals with a corresponding frequency and modulation scheme according to header information of each said packet; and
transmitting said RF burst signals to the CMTS (Cable Modem Termination System).

12. The method of claim 7 wherein substantially all of a fully allotted frequency band for the burst transmitter is sampled and digitized in said transmitting combined data packets to the burst transmitter.

13. A method of transmitting RF return signals from an end user to an RF source comprising:
converting RF return signals into RF return data packets having control information;
combining said RF return data packets with data packets from other sources to obtain a first collection of combined data packets;
multiplexing said first collection of combined data packets with digital telephony data packets containing samples of POTS signals;
transporting said first collection of combined data packets and digital telephony data packets over an optical fiber;
receiving and demultiplexing said first collection of combined data packets and digital telephony data packets;
combining said RF return data packets with data packets from other sources to obtain a second collection of combined data packets;
transmitting said second collection of combined data packets to a burst RF transmitter and extracting a collection of RF return signals from said second collection of combined data packets; and
transmitting said collection of RF return signals to a television signal source.

14. The method of claim 13 wherein said first collection of combined data packets are used to modulate a 1310 nanometer light wave for transmission over said optical fiber.

15. The method of claim 13 wherein said step of converting RF return signals comprises the steps of:
demodulating RF burst signals to recover a raw bit stream;
assembling said raw bit stream into data packets; and
encoding a path address of said RF return signals of each data packet on a header of each data packet to obtain a collection of data packets.

16. The method of claim 13 wherein said step of extracting said collection of RF return signals comprises the steps of:
disassembling said RF return signals into bits;
generating a bit stream segment and assembling said bits into cells or packets of RF return signals;
modulating said cells or packets into RF burst signals with a corresponding frequency and modulation scheme according to the header information of each said packet to obtain an RF return data stream; and
transmitting said RF return data stream a Cable Modem Termination System.

17. The method of claim 13 wherein substantially all of a fully allotted frequency band for the burst transmitter is sampled and digitized in said transmitting said second collection of combined data packets to said burst RF transmitter.

18. The method of claim 13 wherein said data packets from other sources are DSL data packets.
